(19) United States
(12) Patent Application Publication
(10) Pub. No.: US 2026/0319920 A1
(43) Pub. Date: Oct. 15, 2026

(54) PROGRAMMABLE ASSERTS PROVIDED IN HARDWARE FOR DEBUGGING A MACHINE LEARNING MODEL

(71) Applicant: SambaNova Systems, Inc., Palo Alto, CA (US)

(72) Inventors: Pranjali Kartik Bakeri, San Jose, CA (US); Raghu PRABHAKAR, San Jose, CA (US); Paul JORDAN, Austin, TX (US); David Brian JACKSON, Dana Point, CA (US); Matthew VILIM, Redwood City, CA (US); Nathan Zhang, Mountain View, CA (US)

(73) Assignee: SambaNova Systems, Inc., Palo Alto, CA (US)

(21) Appl. No.: 19/244,640

(22) Filed: Jun. 20, 2025

Related U.S. Application Data
(60) Provisional application No. 63/788,291, filed on Apr. 14, 2025.

(51) Int. Cl. G06F 11/362

(52) U.S. Cl. CPC G06F 11/362

(57) ABSTRACT

A system provides machine learning model debugging capability using programmable asserts provided in hardware of coarse grain reconfigurable processor (CGRP) chips. The system includes memory units in the CGRP chips for storing data flows, address flows for addressing the data flows, and software including programming software for programming the machine learning model represented as a flow graph. The system further includes hardware asserts in the CGRP chips for debugging the machine learning model wherein the hardware asserts provide for: (1) detecting out of bound ranges and data equality conditions; (2) checking for bad addresses or data caused due to mis-programming errors, and issuing an assert condition identifying the mis-programming upon detection of the bad addresses or data; and (3) reporting the assert condition to software to enable controlling a response to the reported assert condition based on a failure severity resulting from the programming error reported by the assert condition.

### RELATED APPLICATION

This application claims priority to U.S. Provisional Application No. 63/788,291, filed on Apr. 14, 2025 and titled “Programmable Asserts Provided in Hardware for Debugging a Machine Learning Model”, the contents of which are incorporated by reference herein.

### TECHNICAL FIELD

The present subject matter relates to debugging provided in artificial intelligence (AI) chips. More specifically the present disclosure relates to debugging provided in a machine learning model of AI chips.

### BACKGROUND

Reconfigurable processors, including field programmable gate arrays (FPGAs), can be configured to implement a variety of functions more efficiently or faster than might be achieved using a general-purpose processor executing a computer program. So called Coarse-Grained Reconfigurable Processors (CGRPs) are being developed in which the configurable unit is more complex than used in typical, more fine-grained FPGAs, and may enable faster or more efficient execution of various classes of functions. For example, CGRPs have been proposed that enable implementation of energy-efficient accelerators for machine learning and artificial intelligence workloads.

A machine learning inference or training model is represented as a graph in hardware that can be provided in one or more CGRPs through which data flows and produces a result. The graph flow is configured in the hardware by setting configuration bits to different values. Often these configuration bits are mis-programmed and so it is possible that while the graph flow is executing, somewhere wrong values that are transient or hard to detect occur and corrupt the result. Debugging the machine learning model with these transient corruptions can be time consuming.

### SUMMARY

The present disclosure provides for debugging of a machine learning model with use of hardware asserts to enable detection and correction of errors found when debugging without requiring recompilation during operation of the machine learning model.

Embodiments described herein include a system that provides machine learning model debugging capability using programmable asserts provided in hardware of coarse grain reconfigurable processor (CGRP) chips. The system includes memory units in the CGRP chips for storing data flows, address flows for addressing the data flows, and software including programming software for programming the machine learning model represented as a flow graph. The system further includes hardware asserts in the CGRP chips for debugging the machine learning model wherein the hardware asserts provide for: (1) detecting out of bound ranges and data equality conditions; (2) checking for bad addresses or data caused due to mis-programming errors, and issuing an assert condition identifying the mis-programming upon detection of the bad addresses or data; and (3) reporting the assert condition to software to enable controlling a response to the reported assert condition based on a failure severity resulting from the programming error reported by the assert condition.

In certain embodiments, the hardware making up the hardware asserts are configuration bits. The configuration bits in embodiments are user programmable and can be set by software to control operation of the hardware asserts to provide for items such as detecting out of bound ranges and data equality conditions, checking for bad addresses or data and reporting assert conditions to software. The configuration bits in embodiments can further be programmed through software to alter the out of bound ranges.

In certain embodiments, the failure severity reported by the assert condition is used to control the system response. In certain embodiments when the failure severity is determined to be fatal, execution of the flow graph is stopped. In certain embodiments when the failure severity is not determined to be fatal, the flow graph execution is not stopped, and instead software is informed of a bad address or bad data that is flowing through the graph. Further in certain embodiments when the failure severity is not determined to be fatal during the flow graph execution, debugging hardware collects all violation information and summarizes the information to software at an end of each session run of the flow graph execution.

In certain embodiments, the failure severity level for the checks can be changed by a user. In these embodiments, the failure severity level for the checks can be changed without a need to recompile the flow graph.

In certain embodiments the machine learning model is represented by the flow graph that includes data flows and address flows. In these embodiments, checking for the bad data or addresses includes checking the bound ranges of the data flows and the address flows. In these embodiments, the checking determines if the addresses or data are greater than a minimum range value. Further in these embodiments, the checking determines if the addresses or data are less than a maximum range value. In certain embodiments, the check for the data equality provides a comparison value between source data and reference data.

In some embodiments, the checking and issuing of hardware asserts can be turned on and off by a user. Further, these checks can be turned on and off without a need to recompile the flow graph.

With the programmable hardware asserts providing for such debugging with components described above, certain embodiments provide for programming of the hardware asserts to perform a method that includes: (1) detecting out of bound ranges and data equality conditions; (2) checking for bad addresses or data caused due to mis-programming errors, and issuing an assert condition identifying the mis-programming upon detection of the bad addresses or data; and (3) reporting the assert condition to software to enable controlling a response to the reported assert condition based on a failure severity resulting from the programming error reported by the assert condition.

### BRIEF DESCRIPTION OF THE DRAWINGS

The technology disclosed is described with reference to the drawings, in which:

FIG. 1 is a block diagram illustrating a reconfigurable processor chip architecture system (eg., a CGRP system) for extending dataflow through a network between reconfigurable processor chips that can provide programmable hardware asserts according to embodiments of the present disclosure.

FIG. 2 shows details of a host CPU of FIG. 1 that provides network access through an interconnection network to a pool of CGRPs.

FIG. 3 shows a subsection of the components of FIG. 1 to illustrate the inclusion of programmable hardware asserts according to embodiments.

FIG. 4 shows details of components for the hardware asserts included in a CGRP of FIG. 3 according to embodiments.

FIG. 5 shows further details of the internal components of the hardware asserts of FIG. 4 according to embodiments.

FIG. 6 is a flowchart illustrating operation steps for the programmable hardware asserts according to embodiments.

### DETAILED DESCRIPTION

Embodiments described herein provide programmable asserts in hardware for debugging a machine learning model. The machine learning training model described herein is represented as a graph flow in hardware through which data flows and produces a result. The graph flow is configured in the hardware by setting configuration bits, but when the configuration bits are mis-programmed the wrong values corrupt the result. A problem is presented because of the length of time a model engineer requires to debug these transient corruptions from software without any hardware visibility, particularly when recompiling of the entire graph flow is needed to correct the error discovered in debugging.

The programmable asserts described herein provide a solution to the problem by providing the asserts in hardware. The hardware asserts perform limited functions to enable detecting and correcting graph flow errors without need for compiling, with the functions including: (1) detecting out of bound ranges and data equality conditions; (2) checking for bad addresses or data caused due to mis-programming errors, and issuing an assert condition identifying the mis-programming upon detection of the bad addresses or data; and (3) reporting the assert condition to software to enable controlling a response to the reported assert condition. Further unique things about this solution are that it allows for re-configuring the bound ranges, turning on and off the checks, and changing the severity of the checks without needed to recompile the graphs. A software equivalent would impact performance and would need recompile to elide them.

A CGRP system provides for implementation of the programmable hardware asserts as disclosed herein. The CGRP system may include multiple CGRPs where nodes of a dataflow graph can be split across the multiple CGRPs. Communication between the CGRPs may be achieved using Ethernet DMA (E-DMA) transactions by encapsulating the E-DMA transactions in the Ethernet frame payload. Communication between CGRPs may include communication between a CGRP and another CGRP, and communication between a node of a dataflow graph mapped onto a CGRP and another node of the dataflow graph mapped onto another CGRP. For example, a destination CGRP may send a message to a node on the internal intra-die network of the destination CGRP indicating that the E-DMA data of a current write E-DMA transaction has been written to a local memory of the other CGRP and is available in the local memory. The availability of the E-DMA data can trigger the node to perform a computation using the E-DMA data.

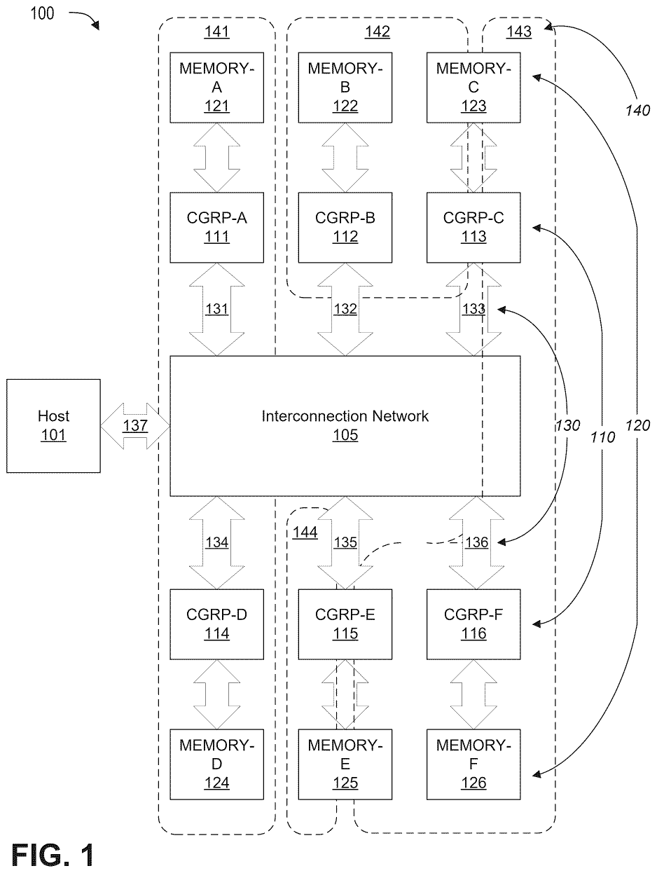

FIG. 1 is a block diagram illustrating an example of a reconfigurable processor chip architecture system (eg., a CGRP system) 100 that can provide programmable hardware asserts according to embodiments disclosed herein. As illustrated, the CGRP system 100 includes a host 101, a number of course grained reconfigurable processors CGRPs (110) including CGRPs 111-116, an interconnection network 105 and communication links 130 (131-137) that connect the host 101 and the CGRPs 110 to the interconnection network 105. The host 101 runs runtime processes and may also be used to run computer programs, such as a compiler. In some implementations, the compiler may run on a computer separate from host 101. The CGRA system 100 may also include memories 120 respectively coupled to the CGRPs 110 including memory-A 121 coupled to CGRP-A 111, memory-B 122 coupled to CGRP-B 112, memory-C 123 coupled to CGRP-C 113, memory-D 124 coupled to CGRP-D 114, memory-E 125 coupled to CGRP-E 115, and memory-F 126 coupled to CGRP-F 116. The memories 120 can be any type of memory, including dynamic data rate (DDR) dynamic random-access memory (DRAM), high-bandwidth memory (HBM), static memory, or flash memory.

The communication links 130 can be any type of communication link, parallel or serial, electrical or optical, but in some implementations, each may be one or more physical Ethernet links. The Ethernet links may be compliant with any version of the Ethernet specification. The interconnection network 105 may have any type of topology depending on the system design and particular embodiment. In some implementations, the interconnection network 105 may be implemented as direct links between pairs of devices where each device is one of CGRP 111-116 or host 101. For example, the host may have 6 individual links that respectively directly connect to the 6 CGRPs 111-116 and each CGRP may, in addition to its link connecting to the host 101, have a link to each of the other CGRPs 111-116. In that implementation, CGRP-A 111 has a first link connecting directly to the host 101, a second link connecting directly to CGRP-B 112, a third link connecting directly to CGRP-C 113, a fourth link connecting directly to CGRP-D 114, a fifth link connecting directly to CGRP-E 115, and a sixth link connecting directly to CGRP-F 116; so link 131 may include 6 individual links. In other embodiments, the interconnection network 105 may include a bus structure, a switching fabric, or one or more switches and/or routers that are able to route a transaction from an originating CGRP 110 or host 101 to a destination CGRP 110 or host 101.

Each of the CGRPs 110 may include a grid of compute units and memory units interconnected with an internal switching array fabric. The CGRPs 110 can be configured by downloading configuration files from the host 101 to configure the CGRPs 110 to execute one or more graphs (140), including flow graphs 141-144, that define dataflow computations, and can implement any type of functionality including, but not limited to neural networks. The communication links 130 and the interconnect network 101 provide a high degree of connectivity that can increase the dataflow bandwidth between the CGRPs 110 and enable the CGRPs 110 to cooperatively process large volumes of data via the dataflow operations specified in the execution graphs 141-144.

A set of flow graphs 141-144 illustrated by dashed lines can be assigned to the CGRA system 100 for execution. The graphs 141-144 are overlaid on the block diagram of the CGRA system 100 showing how they may be assigned to the CGRPs 110. In the example shown, graph1 141 is assigned to CGRP-A 111 and CGRP-D 114, graph2 142 is assigned to CGRP-B 112 and sections of CGRP-C 113, graph3 143 is assigned to sections of CGRP-C 113, CGRP-F 116, and sections of CGRP-E 115, while graph4 144 is assigned to sections of CGRP-E 115. While the set of graphs 141-144 is statically depicted, one of skill in the art will appreciate that the execution graphs are likely not synchronous (i.e., of the same duration) and that the partitioning within a CGR computing environment will likely be dynamic as execution graphs are completed and replaced.

As can be understood from FIG. 1, nodes of a graph may be distributed across multiple CGRPs. Nodes of a graph within a CGRP may communicate using internal communication paths of the CGRP, but communication between nodes of a single graph in different CGRPs may use Ethernet direct memory access (E-DMA) or peer-to-peer (P2P) communication over the links 130 and interconnection network 105.

For example in FIG. 1, a flow graph1 141 is spread across multiple CGRPs with CGRP-A 111 configured to execute a first node of the graph1 141, and another CGRP-D 114 configured to execute a second node of the same graph1 141. The first node of graph1 141 may send data to the second node of graph1 141. For the purposes of this disclosure, in a typical system, a connected processor of host 101 may be used to move the data from the first node to the second node. A CGRP system for extending dataflow graphs to memory-to-memory DMA functionality using message-based triggers allows CGRP-A 111 to send the data from the first node directly to CGRP-D 114 without passing through the host 101.

As mentioned above, the host 101 may configure the CGRPs 110 by downloading configuration bit files to the CGRPs 110. This may be accomplished by sending the configuration bit files over the communication links 130 and interconnection network 105. The configuration bit files can include information to configure individual units within the CGRPs 110 (which are described in more detail below) as well as the internal communication paths between those units. The configuration bit files may be static for the duration of execution of a graph and configure a portion of one of CGRPs 111-116 (or the entire CGRP) to execute one or more nodes of an execution graph 141-144. Although the detailed description is focused on extending dataflow graphs to memory-to-memory direct memory access (DMA) functionality using message-based triggers, other functionality is envisioned to be covered by the described subject matter. Discussion of extending dataflow graphs to memory-to-memory direct memory access (DMA) functionality using message-based triggers is not intended to limit the detailed description to extending dataflow graphs to memory-to-memory direct memory access (DMA) functionality using message-based triggers or to limit the detailed description in any way.

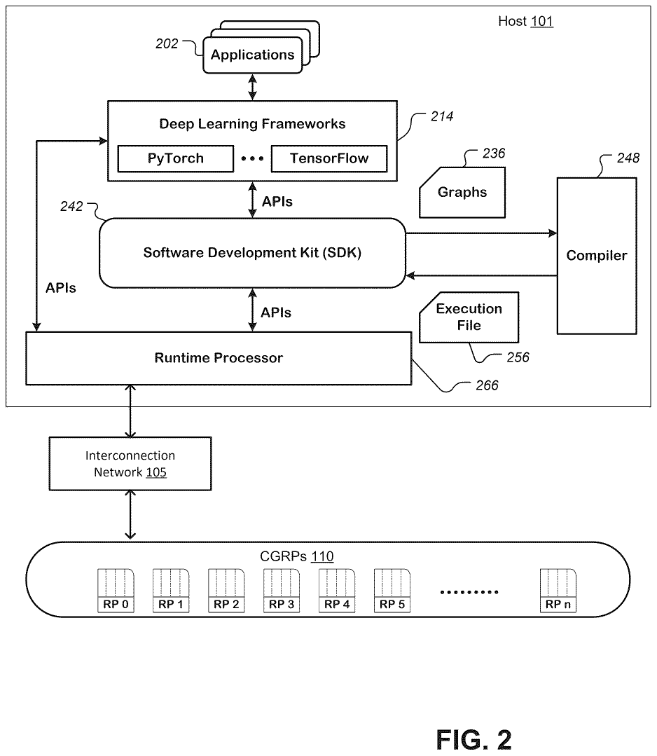

FIG. 2 shows details of a host CPU compute environment 101 of FIG. 1 that provides network access through interconnection network 105 to a pool of CGRPs 110 that can be rapidly configured. Although not shown, the CGRPs can further be connected to memory units 120 as shown in FIG. 1. The host 101 and CGRPs 110 are further interconnected by an interconnect network 105 as shown in FIG. 1.

The host 101 includes a runtime processor 266 that manages resource allocation, memory mapping, and execution of the configuration files for applications requesting execution from the runtime processor 266 that are distributed as flow graphs to the CGRPs 110. The host 101 also provides applications 202 that are to be executed as flow graphs on the CGRPs 110 in a distributed fashion by programming the individual compute and memory components to asynchronously receive, process, and send data and control information. In the CGRPs 110, computation can be executed as deep, nested dataflow pipelines that exploit nested parallelism and data locality very efficiently. These dataflows contain several stages of computation, where each stage reads data from one or more input buffers with an irregular memory access pattern, performs computations on the data while using one or more internal buffers to store and retrieve intermediate results, and produce outputs that are written to one or more output buffers. The structure of these dataflow pipelines depends on the control and dataflow graph representing the application. Pipelines can be arbitrarily nested and looped within each other.

The applications 202 comprise high-level programs. A high-level program is source code written in programming languages like C, C++, Java, JavaScript, Python, and Spatial, for example, using deep learning frameworks 214 like PyTorch, TensorFlow, ONNX, Caffe, and Keras. The high-level program can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL. In one example, the high-level program can implement a convolutional neural network with several processing layers, such that each processing layer can include one or more nested loops. The high-level program can execute irregular memory operations that involve accessing inputs and weights and performing matrix multiplications between the inputs and the weights. The high-level program can include nested loops with high iteration count and loop bodies that load and multiply input values from a preceding processing layer with weights of a succeeding processing layer to produce an output for the succeeding processing layer. The high-level program can have loop-level parallelism of the outermost loop body, which can be exploited using coarse-grained pipelining. The high-level program can have instruction-level parallelism of the innermost loop body, which can be exploited using loop unrolling, SIMD vectorization, and pipelining.

Regarding loops in the high-level programs of the applications 202, loops directly nested in a loop body are termed the child loops of the outer parent loop. A loop is called an innermost loop if it does not have any children, i.e., there are no nested loops within its body. A loop is an outermost loop if it does not have a parent, i.e., it is not nested within another loop's body. An imperfectly nested loop has a body with a mix of non-looping statements (e.g., primitive arithmetic, logical, and relational operations) and one or more child loops. Parallelism in the imperfectly nested loops can be exploited at any or all loop levels, and in the operations that comprise loop bodies. Parallelism can occur in multiple forms such as fine-grained and coarse-grained pipeline parallelism, data parallelism, and task parallelism.

Software development kit (SDK) 242 generates computation flow graphs (e.g., data flow graphs, control graphs) 236 of the high-level programs of the applications 202. The SDK 142 transforms the input behavioral description of the high-level programs into an intermediate representation such as the flow graphs 236. This may include code optimization steps like false data dependency elimination, dead-code elimination, and constant folding. The flow graphs 236 encode the data and control dependencies of the high-level programs.

The flow graphs 236 include nodes and edges. The nodes can represent compute operations and memory allocations. The edges can represent data flow and flow control. In some implementations, each loop in the high-level programs can be represented as a “controller” in the flow graphs 236. The flow graphs 236 support branches, loops, function calls, and other variations of control dependencies. In some implementations, after the flow graphs 236 are generated, additional analyses or optimizations focused on loop transformations can be performed, such as loop unrolling, loop pipelining, loop fission/fusion, and loop tiling.

The SDK 242 also supports programming the reconfigurable processors in the pool of reconfigurable data flow resources 110 at multiple levels, for example, from the high-level deep learning frameworks 114 to C++ and assembly language. In some implementations, the SDK 242 allows programmers to develop code that runs directly on the reconfigurable processors. In other implementations, the SDK 242 provides libraries that contain predefined functions like linear algebra operations, element-wise tensor operations, non-linearities, and reductions required for creating, executing, and profiling the flow graphs 236 on the reconfigurable processors. The SDK 242 communicates with the deep learning frameworks 214 via APIs.

A compiler 248 transforms the flow graphs 236 into a hardware-specific configuration, which is specified in an execution file 256 generated by the compiler 248. In one implementation, the compiler 248 partitions the flow graphs 136 into memory allocations and execution fragments, and these partitions are specified in the execution file 256. Execution fragments represent operations on data. An execution fragment can comprise portions of a program representing an amount of work. An execution fragment can comprise computations encompassed by a set of loops, a set of graph nodes, or some other unit of work that requires synchronization. An execution fragment can comprise a fixed or variable amount of work, as needed by the program. Different ones of the execution fragments can contain different amounts of computation. Execution fragments can represent parallel patterns or portions of parallel patterns and are executable asynchronously.

In some implementations, the partitioning of the flow graphs 236 into the execution fragments includes treating calculations within at least one innermost loop of a nested loop of the flow graphs 236 as a separate execution fragment. In other implementations, the partitioning of the flow graphs 236 into the execution fragments includes treating calculations of an outer loop around the innermost loop of the flow graphs 236 as a separate execution fragment. In the case of imperfectly nested loops, operations within a loop body up to the beginning of a nested loop within that loop body are grouped together as a separate execution fragment.

Memory allocations represent the creation of logical memory spaces in on-chip and/or off-chip memories for data required to implement the flow graphs 236, and these memory allocations are specified in the execution file 256. Memory allocations define the type and the number of hardware resources (functional units, storage, or connectivity components). Main memory (e.g., DRAM) is off-chip memory for which the memory allocations can be made. Scratchpad memory (e.g., SRAM) is on-chip memory for which the memory allocations can be made. Other memory types for which the memory allocations can be made for various access patterns and layouts include read-only lookup-tables (LUTs), fixed size queues (e.g., FIFOs), and register files.

The compiler 248 binds memory allocations to virtual memory units and binds execution fragments to virtual compute units, and these bindings are specified in the execution file 256. In some implementations, the compiler 248 partitions execution fragments into memory fragments and compute fragments, and these partitions are specified in the execution file 256. A memory fragment comprises address calculations leading up to a memory access. A compute fragment comprises all other operations in the parent execution fragment. In one implementation, each execution fragment is broken up into a plurality of memory fragments and exactly one compute fragment. In one implementation, the compiler 248 performs the partitioning using reverse dataflow analysis such that inputs to an address used in a memory access are recursively flagged until the compiler 248 reaches either constant values or (bound) loop/pattern iterators. A single execution fragment can produce one or more memory fragments, depending on how many memory accesses exist in the original loop body. In cases where the same memory addressing logic is shared across multiple memory accesses, address calculation may be duplicated to create multiple memory fragments from the same execution fragment.

The memory fragments of the execution fragments are configured to index into data structures. At least one of the memory fragments indexes into a data structure in the logical memory spaces of one of the memory allocations. Each compute and memory fragment preserves information about all loops whose loop bodies directly contain the operations in the corresponding execution fragment. In one implementation, this corresponds to replicating the calculation of the loop iterators of each loop into each compute and memory fragment. This replication allows each fragment to preserve the same iterative behavior as the original program while also allowing distributed calculation of loop iterators.

The compiler 248 assigns the memory fragments to the virtual memory units and assigns the compute fragments to the virtual compute units, and these assignments are specified in the execution file 256. Each memory fragment is mapped operation-wise to the virtual memory unit corresponding to the memory being accessed. Each operation is lowered to its corresponding configuration intermediate representation for that virtual memory unit. Each compute fragment is mapped operation-wise to a newly allocated virtual compute unit. Each operation is lowered to its corresponding configuration intermediate representation for that virtual compute unit.

The compiler 248 allocates the virtual memory units to physical memory units of a CGRP and allocates the virtual compute units to physical compute units of the CGRP, and these allocations are specified in the execution file 256. The compiler 248 places the physical memory units and the physical compute units onto positions in an array of configurable units of the CGRP and routes data and control networks between the placed positions, and these placements and routes are specified in the execution file 256. In one implementation, this includes allocating physical resources such as counters and registers within each physical memory and compute unit, and these allocations are specified in the execution file 256.

The compiler 248 translates the applications 102 developed with commonly used open-source packages such as Keras and PyTorch into reconfigurable processor specifications. The compiler 248 generates the configuration files with configuration data for the placed positions and the routed data and control networks. In one implementation, this includes assigning coordinates and communication resources of the physical memory and compute units by placing and routing units onto the array of the processor while maximizing bandwidth and minimizing latency.

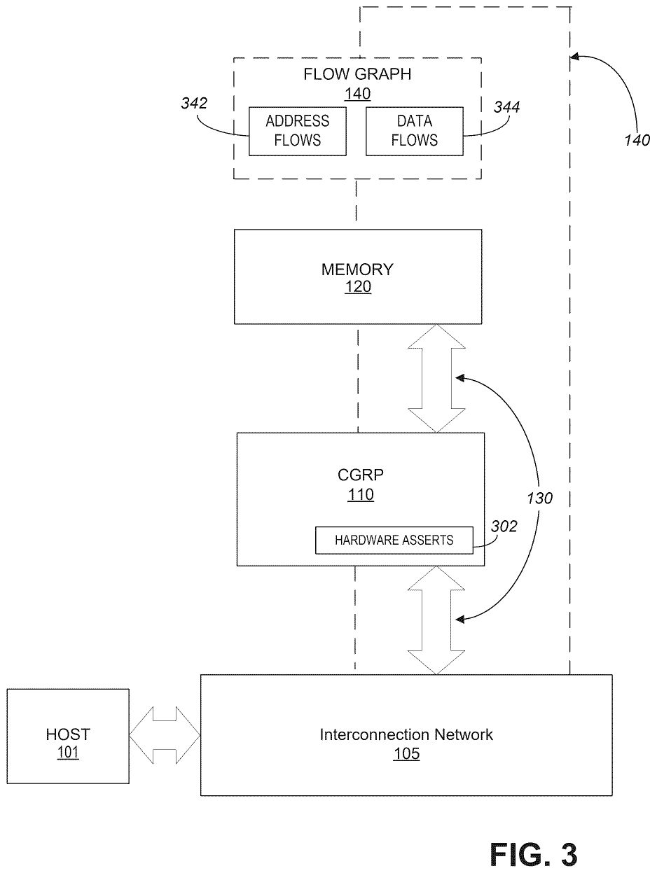

FIG. 3 shows a subsection of the components of FIG. 1 to illustrate the inclusion of programmable hardware asserts according to embodiments. As shown in FIG. 3, the hardware asserts 302 are included in the CGRPs 110. The hardware asserts are programmable and can be configured by using the configuration bits within the CGRPs 110. Programming of the hardware asserts as well as input and output communications from the programmable asserts can be handled through the host 101 using the interconnection network 105 and communication links 130.

FIG. 3 further shows the flow graphs 140 that include data flows 342 and address flows 344 that are monitored by the hardware asserts 302. The flow graphs include the address flows 344 and data flows 342 that are being programmed into memory 120, and the hardware asserts 302 monitor the address flows 342 and data flows 344 to detect bad data or addresses caused due to mis-programming errors. The hardware asserts 302 upon identification of the mis-programmed data flows or address flows report the assert condition over the communication link 130.

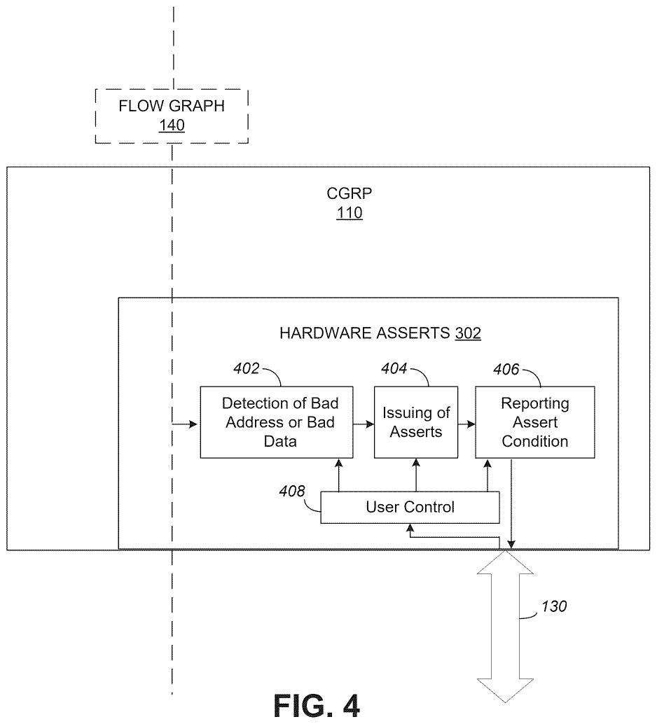

FIG. 4 shows details of components included in the hardware asserts 302 as included in a CGRP 110 of FIG. 3 according to embodiments. The hardware asserts 302 include an element 402 for detection of bad addresses, an element 404 for issuing of asserts, an element 406 for reporting assert conditions, and an element 408 for user control of components in the elements 402, 404 and 406. The element for detection of bad data or addresses 402 is connected to the flow graph 140 to receive and monitor the data and address flows. Once an error is in the flow graph 140 in detected in element 402 that meets criteria for issuing an assert, an assert is reported that is issued in the element 404 for issuing of asserts. The assert condition and information regarding the flow graph error is then reported in the element 406 for reporting assert conditions. The user control element 408 allows a user to set the bounds for detection of an assert condition in element 402, to set turn on and off of the issuance of asserts in element 404, and to set control of the reporting information in element 406. As indicated previously, all of the elements of the hardware asserts 302 can be programmed by setting configuration bits in the CGRP 110.

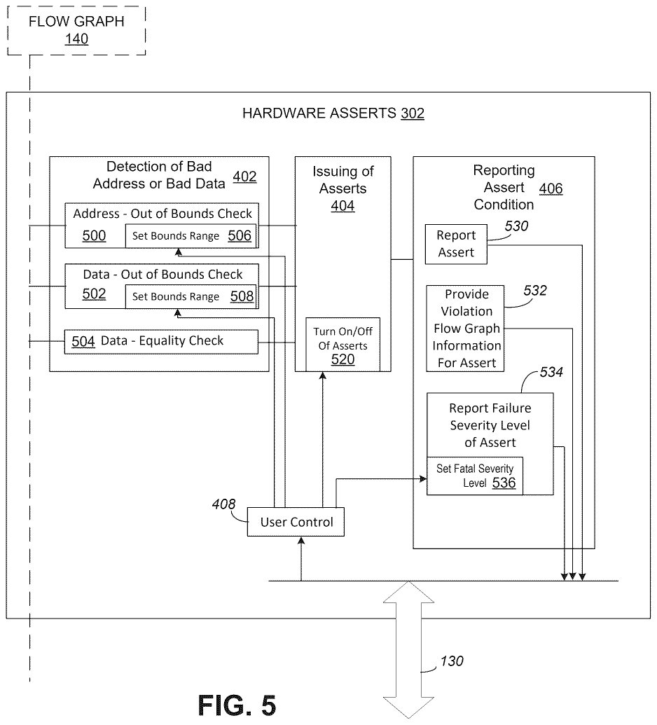

FIG. 5 shows further details of the internal components of the hardware asserts 302 of FIG. 4 according to embodiments. The element 402 for detection of bad address or bad data of the hardware asserts 302 includes elements for a check for out of bounds addresses 500 and a check for out of bounds data 502. Both elements 500 and 502, thus, together function to detect bad data or addresses in the flow graph 140 caused due to mis-programming errors.

The flow graph 140 includes both data flows and address flows. The element 502 for detecting bad data includes checking the out of bounds ranges for the data flows. The element 500 for detecting bad addresses includes checking the out of bounds ranges for the address flows. The out of bounds check elements 500 and 502 detect a lower bounds error when the address or data that should be greater than a minimum range value are detected during a check for compliance. The out of bounds check elements 500 and 502 detect an upper bounds error when the address or data that should be lower than a maximum range value are detected during a check for compliance.

The data flow bound range limits outside of which an error is detected using element 500 can be set using configuration bits forming a mechanism for setting bound ranges 506 within element 500. Similarly, the address flow ranges outside of which an error is detected using element 502 can be set using configuration bits forming a mechanism for setting bound ranges 508 within element 502. The user control 408 allows setting the bound ranges in elements 506 and 508.

The detection of bad address and bad data element 402 further includes a data equality check element 504. The data equality check element 504 provides an error check to the data flows using data equality conditions. The checking for data equality conditions can provide a comparison value between source data and reference data. The reference data can be stored in memory, provided with the data flow, or calculated from the data flow parameters.

The issuing of asserts element 404 of the hardware asserts 302 receives an indication of detection of bad addresses or bad data from element 402 and issues asserts. The assert issuance from element 404 can be turned on and off with element 520. A user can control turn on and turn off of the assert issuance using user control 408.

Reporting of the assert condition element 406 of the hardware asserts 302 reports the asserts and information about the asserts to software for processing over the communications link 130. The assert that is issued is reported using the assert report element 530. Flow graph information where the data violation or address violation occurred causing the assert issuance is provided from the element 532. Finally, a failure severity level is provided for the assert issued through element 534.

The failure severity level reported by element 534 determines if a threshold is reached where the failure level is fatal. When the failure level is reported as fatal, execution of the flow graph is stopped. Such a failure level is variable and can be set by the user control 408 using element 536 to set the fatal severity level within the failure severity level reporting element 534.

When the failure severity level is not determined to be fatal, the flow graph will continue execution. The software is informed through the communications link 130 that the bad address or data are flowing through the graph and a failure has been detected, even though not fatal. Further, when the failure is not determined to be fatal, the debugging hardware collects all the violation information and summarizes the information to software from element 532 over the communications link 130. The summarized assert information can be provided at the end of a section run of the graph execution.

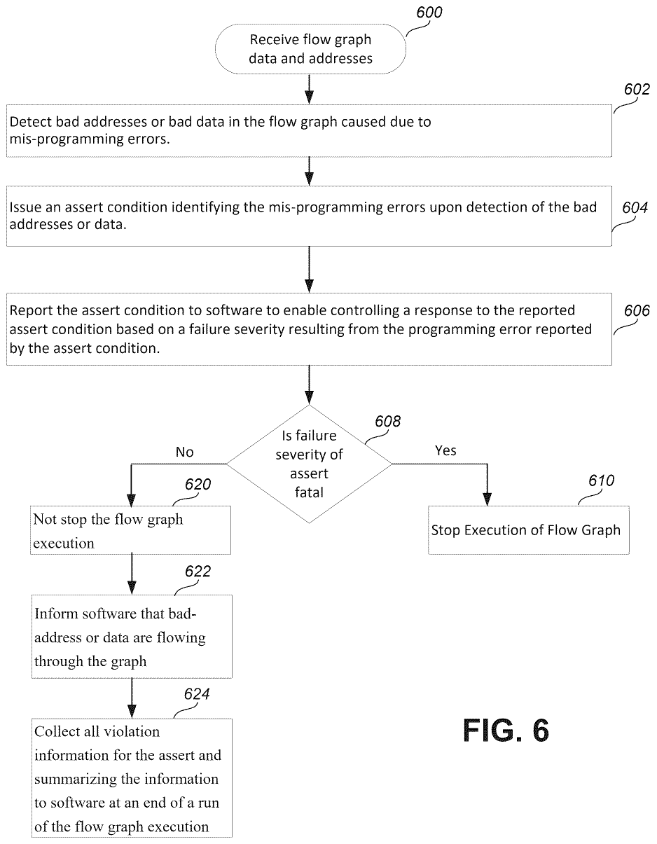

FIG. 6 is a flowchart illustrating operation steps for the programmable hardware asserts according to embodiments. Operation begins in step 600 with receipt of data and address flows from a flow graph. In step 602, detection is made for bad addresses or data in the flow graph caused due to mis-programming errors. Next is step 604, upon detection of the bad address or data, the operation issues an assert condition identifying the mis-programming error. In step 606 the assert condition is reported to software to enable controlling a response to the reported assert condition based on a failure severity resulting from the programming error reported by the assert condition.

In subsequent operation steps in the flowchart of FIG. 6, whether the failure level is fatal is next handled beginning in step 608 which determines if the failure severity level is fatal. If the failure level is determined to be fatal in step 608, the processor operation of executing the flow graph is stopped by software in step 610. If the failure severity is not fatal as determined in step 608, the flow graph execution is not stopped in step 620. With the assert condition asserted, however, in step 622 the software informs the system that bad data or addresses are flowing through the flow graph. Further, in step 624 a collection of all violation information for the assert is summarized and the summary information is provided to software at an end of a run of the flow graph execution.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

What is claimed is:

1. An apparatus providing machine learning model debugging capability comprising:
coarse grain reconfigurable processor (CGRP) chips;
memory units in the CGRP chips for storing data flows, address flows for addressing the data flows, and software including programming software for programming the machine learning model represented as a flow graph; and
hardware asserts provided in the CGRP chips for debugging the machine learning model wherein the hardware asserts provide for:
detecting bad data or addresses caused due to mis-programming errors;
issuing an assert condition identifying the mis-programming upon detection of the bad addresses or data; and
reporting the assert condition to software to enable controlling a response to the reported assert condition based on a failure severity resulting from the programming error reported by the assert condition.

2. The apparatus of claim 1,
wherein when the failure severity is determined to be fatal, stopping execution of the flow graph,
wherein when the failure severity is not determined to be fatal, not stopping the graph execution, and instead informing software that bad-address or data are flowing through the graph, and
wherein when the failure is not determined to be fatal during the graph execution, the debugging hardware collects all violation information and summarizes the information to software at an end of each section run of the graph execution.

3. The apparatus of claim 1, wherein the failure severity can be changed by a user.

4. The apparatus of claim 1,
wherein the machine learning is represented by the flow graph including the data flows, and
wherein the failure severity can be changed without a need to recompile the flow graph.

5. The apparatus of claim 1, wherein the hardware asserts comprise configuration bits which are user programmable.

6. The apparatus of claim 5, wherein the user can set the configuration bits to different values through software to alter out of bound ranges for the data flows.

7. The apparatus of claim 1, wherein the machine learning is represented by the flow graph including the data flows and the detecting for the bad data includes checking bound ranges for the data flows.

8. The apparatus of claim 1, wherein the machine learning is represented by the flow graph including address flows and the detecting includes checking for out of bound ranges for the address flows.

9. The apparatus of claim 1,
wherein the machine learning is represented by the flow graph including the data flows,
wherein the detecting for the bad data or addresses includes checking bound ranges for the data and address flows, and
wherein software allows a user to alter the bound ranges by setting configuration bits to different values.

10. The apparatus of claim 9, wherein the address or the data that should be greater than a minimum range value are checked for compliance.

11. The apparatus of claim 9, wherein the address or the data that should be less than a maximum range value are checked for compliance.

12. The apparatus of claim 1, wherein the detecting for the bad data includes checking data equality conditions.

13. The apparatus of claim 12, wherein the checking for the data equality conditions provides a comparison value between source data and reference data.

14. The apparatus of claim 1, wherein the issuing and reporting of hardware asserts can be turned on and off by a user.

15. The apparatus of claim 1,
wherein the machine learning is represented by the flow graph including data flows, and the detecting for bad data includes checking bound ranges for the data flows, and
wherein the bound ranges can be changed without a need to recompile the flow graph.

16. The apparatus of claim 1,
wherein issuing of hardware asserts can be turned on and off without a need to recompile.

17. A method of providing a machine learning model debugging capability using debugging hardware in chip units for debugging the machine learning model, wherein the machine learning model is represented as a flow graph, wherein the debugging hardware is configured to perform the method comprising:
detecting bad data or addresses caused by mis-programming errors;
issuing an assert condition identifying the mis-programming error upon detection of the bad addresses or data; and
reporting the assert condition to software to enable controlling a response to the reported assert condition based on a failure severity resulting from the mis-programming error reported by the assert condition.

18. The method of claim 17,
wherein when the failure severity is determined to be fatal, stopping execution of the graph,
wherein when the failure severity is not determined to be fatal, not stopping the graph execution, and instead informing software that bad-address or data are flowing through the graph, and
wherein when the failure is not determined to be fatal during the graph execution, additional hardware collects all violation information and summarizes the violation information to the software at an end of each section run of the graph execution.

19. The method of claim 17, wherein the machine learning is represented by the flow graph including data flows, and the detecting bad data includes checking bound ranges for the data flows.

20. The method of claim 17, wherein the machine learning is represented by the flow graph including address flows and the detecting bad data or addresses includes checking for out of bound ranges for the address flows.
